(19) United States
(12) Patent Application Publication
(10) Pub. No.: US 2026/0299697 A1
(43) Pub. Date: Oct. 1, 2026

(54) INFORMATION PROCESSING METHOD AND ELECTRONIC DEVICE

(71) Applicant: Lenovo (Beijing) Limited, Beijing (CN)

(72) Inventors: Xinxiao YANG, Beijing (CN); Jiapu ZHANG, Beijing (CN)

(21) Appl. No.: 19/633,503

(22) Filed: Mar. 30, 2026

(30) Foreign Application Priority Data
Mar. 31, 2025 (CN) 202510397593.8

(51) Int. Cl. G06F 3/01; G06F 3/0354; G06F 3/041

(52) U.S. Cl. CPC G06F 3/016; G06F 3/03545; G06F 3/0416

(57) ABSTRACT

An information processing method includes determining that a target application meets a preset condition, controlling a touchscreen to respond to a vibration parameter of the target application at a first moment, obtaining touch information of a stylus on the touchscreen at a second moment later than the first moment, and controlling the touchscreen to send the vibration parameter to the stylus, to enable the stylus to vibrate based on the vibration parameter.

### CROSS-REFERENCE TO RELATED APPLICATION

This application claims priority to Chinese Patent Application No. 202510397593.8, filed on Mar. 31, 2025, the entire content of which is incorporated herein by reference.

### TECHNICAL FIELD

The present disclosure generally relates to the field of touch technology and, more particularly, to an information processing method and electronic device.

### BACKGROUND

When a user writes on a touchscreen using a stylus, to achieve a vibration effect of the stylus, the touchscreen usually feeds back the touch event of the stylus to an application. Then, the application responds to the touch event and feeds back vibration parameter to the stylus, resulting in a long vibration parameter feedback path and vibration delay.

### SUMMARY

In accordance with the present disclosure, there is provided an information processing method including determining that a target application meets a preset condition, controlling a touchscreen to respond to a vibration parameter of the target application at a first moment, obtaining touch information of a stylus on the touchscreen at a second moment later than the first moment, and controlling the touchscreen to send the vibration parameter to the stylus, to enable the stylus to vibrate based on the vibration parameter.

Also in accordance with the present disclosure, there is provided an information processing method including responding to a touch operation performed by a stylus on a display area of a target application of an electronic device, and receiving a vibration parameter of the target application sent by a touchscreen of the electronic device. The vibration parameter is sent to the touchscreen by the electronic device before the touch operation is detected in response to determining that the target application meets a preset condition. The method further includes, based on the vibration parameter, controlling a vibration module to vibrate.

Also in accordance with the present disclosure, there is provided an electronic device including a touchscreen, and a processor configured to determine that a target application meets a preset condition, control the touchscreen to respond to a vibration parameter of the target application at a first moment, obtain touch information of a stylus on the touchscreen at a second moment later than the first moment, and control the touchscreen to send the vibration parameter to the stylus, to enable the stylus to vibrate based on the vibration parameter.

### BRIEF DESCRIPTION OF THE DRAWINGS

FIG. 1 is a flowchart of an information processing method consistent with the present disclosure.

FIG. 2 is a flowchart of another information processing method consistent with the present disclosure.

FIG. 3 is a flowchart of another information processing method consistent with the present disclosure.

FIG. 4 is a flowchart of another information processing method consistent with the present disclosure.

FIG. 5 is a hardware structure diagram of an electronic device consistent with the present disclosure.

### DETAILED DESCRIPTION OF THE EMBODIMENTS

To make the objectives, technical solutions, and advantages of the embodiments of the present disclosure clearer, the technical solutions of the present disclosure will be described below with reference to the accompanying drawings. Obviously, the described embodiments are only some embodiments of the present disclosure, not all embodiments. All other embodiments obtained by those skilled in the art based on the described embodiments without creative effort are within the scope of the present disclosure.

In related technologies, when a user writes on a touchscreen using a stylus, to achieve a vibration effect of the stylus, the common method is for the touchscreen to feed back the touch event of the stylus to an application, and then the application, in response to the touch event, feeds back vibration parameter to the stylus. This method has the following problems. First, the feedback path of the vibration parameter is long, involving multiple processes, including the touchscreen detecting the touch event, transmitting the touch event to the application, the application sending the vibration parameter back to the touchscreen based on the touch event, and the touchscreen then transmitting the vibration parameter to the stylus. This complex feedback path leads to a delay in the transmission of the vibration parameter. Secondly, since the transmission of vibration parameter involving communication and processing between multiple modules may increase the system's load, especially under high-frequency touch operations. Furthermore, the above method may also affect the user's writing experience, as the delay in vibration feedback may make the user feel a lack of coordination between the pen tip and the screen, thus reducing the naturalness and smoothness of writing. Finally, the above method makes it difficult to achieve fine-grained vibration control for different applications or writing scenarios, because each touch needs to be processed by the application, making it difficult to achieve rapid and flexible adjustment of the vibration parameter.

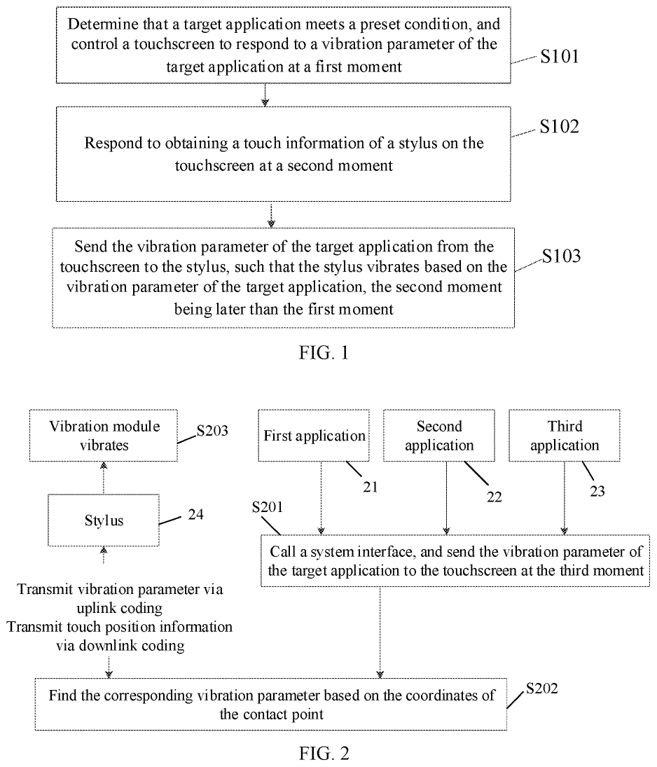

Therefore, the present disclosure provides an information processing method applied to an electronic device. The information processing method, as shown in FIG. 1, includes the following.

At S101, a target application meets a preset condition is determined, and a touchscreen is controlled to respond to a vibration parameter of the target application at a first moment.

Consistent with the present disclosure, the touchscreen refers to a display screen capable of detecting stylus touch operations. The stylus refers to an electronic device that allows touch operations on the touchscreen. Vibration parameter refers to parameter information used to control the vibration of the stylus. An implementation environment of the information processing method includes an electronic device and a stylus, where the electronic device includes a touchscreen.

Consistent with the present disclosure, the target application can be an application whose interface includes a handwriting area, i.e., a touch area, such as a notepad application or a drawing application. The target application meeting the preset condition can be the target application is launched, or the interface of the target application is started, such as application startup initialization.

Consistent with the present disclosure, the electronic device can determine that the target application meets the preset condition through the processor and control the touchscreen to respond to the vibration parameter of the target application at the first moment. That is, at the first moment, the touchscreen can respond to an operation object that needs the vibration parameter of the target application, such as an active stylus.

At S102, the touch information of the stylus on the touchscreen is obtained at a second moment.

Consistent with the present disclosure, the touchscreen can obtain touch information by detecting the touch operation of the stylus. The touch information may include a target touch area when the stylus makes contact with the surface of the touchscreen.

At S103, the vibration parameter of the target application is sent from the touchscreen to the stylus, such that the stylus vibrates based on the vibration parameter of the target application. The second moment is later than the first moment.

Consistent with the present disclosure, the touchscreen obtains the touch information of the stylus on the touchscreen at the second moment and then sends the vibration parameter of the target application to the stylus based on the touch information, such that the stylus vibrates based on the vibration parameter of the target application.

The information processing method provided in the present disclosure, applied to an electronic device, includes: determining that a target application meets the preset condition; controlling a touchscreen to respond to vibration parameter of the target application at a first moment; obtaining touch information of a stylus on the touchscreen at a second moment; sending the vibration parameter of the target application from the touchscreen to the stylus, such that the stylus vibrates based on the vibration parameter of the target application, the second moment being later than the first moment. Therefore, by sending the vibration parameter of the target application to the touchscreen before the stylus performs a touch operation, and sending the vibration parameter to the stylus when the stylus performs the touch operation, the feedback path of the vibration parameter is significantly shortened, reducing the number of processes and delays in the transmission of vibration parameter, and has the advantages of reducing vibration parameter transmission delay, reducing system load, improving user writing experience, and achieving precise vibration control.

In some embodiments, process S101, determining that the target application meets the preset condition, and controlling the touchscreen to respond to the vibration parameter of the target application at a first moment, includes: detecting that an interface of the target application is launched or the target application is launched, and sending the vibration parameter of the target application to the touchscreen at a third moment, such that the touchscreen controls the sending of vibration parameter to the stylus after the first moment, the third moment being earlier than the first moment.

Consistent with the present disclosure, the target application meeting the preset condition includes the launch of the interface of the target application or the launch of the target application, such as the application startup initialization.

Consistent with the present disclosure, the third moment can be set as the moment when the target application launches or the interface launches.

In some embodiments, as shown in FIG. 2, upon detecting that the interface of the target application is launched or the target application is launched, at S201, the target application can be controlled to send the vibration parameter of the target application to the touchscreen at the third moment by calling the system interface, such that the touchscreen can respond to the operation object that needs the vibration parameter of the target application at the first moment, the operation object being, for example, an active stylus; and the touchscreen controls the sending of vibration parameter to the stylus after the first moment. The target application may include multiple applications, such as a first application 21, a second application 22, a third application 23, etc. Then, the touchscreen responds by obtaining the touch information of the stylus on the screen at the second moment, for example, the coordinates of the contact point. The stylus 24 can either use downlink coding to encode the touch position information, including the coordinates of the contact point of stylus on the touchscreen, onto the touchscreen, or the touchscreen can automatically recognize the coordinates of the contact point of stylus on the touchscreen. Then, at S202, the touchscreen finds the corresponding vibration parameter based on the coordinates of the contact point of stylus on the touchscreen and encodes the vibration parameter onto the stylus 24 using uplink coding. At S203, the stylus drives the vibration module to vibrate.

Consistent with the present disclosure, by sending the vibration parameter of the target application to the touchscreen at the third moment when the interface of the target application is detected to be launched or when the target application is launched, the touchscreen controls the sending of vibration parameter to the stylus after the first moment. This ensures that the vibration parameter can be transmitted to the touchscreen as early as possible, and that the stylus can receive and respond to the vibration parameter in a timely manner, thereby reducing the delay in vibration feedback and improving the user experience.

In some embodiments, process S101, determining that the target application meets the preset condition, and controlling the touchscreen to respond to the vibration parameter of the target application at a first moment, includes: responding to the target application meeting the preset condition, creating a system call service at a fourth moment to obtain the vibration parameter of the corresponding target application, and sending the vibration parameter to a touchscreen controller via an inter-process communication interface at a third moment, such that the touchscreen responds to the vibration parameter of the target application at the first moment, with the fourth moment earlier than the third moment, and the third moment earlier than the first moment.

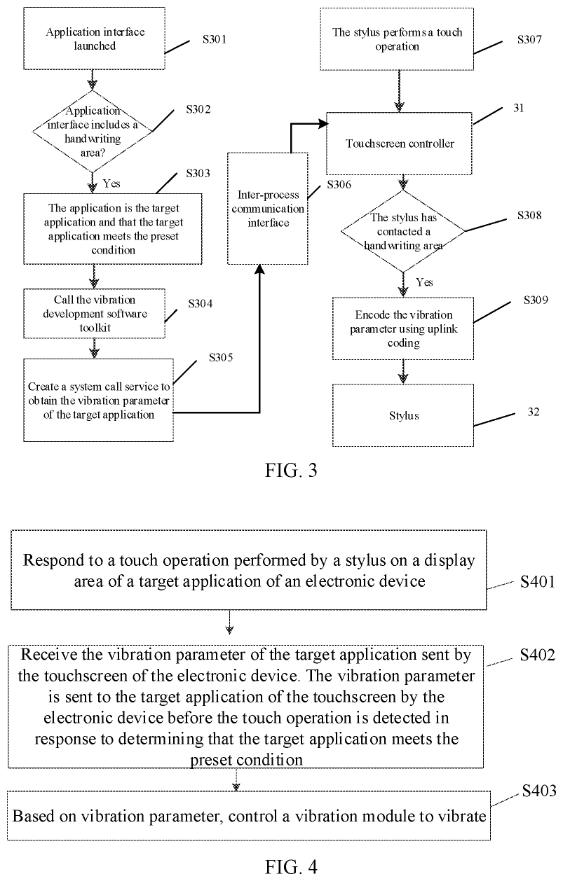

Specifically, as shown in FIG. 3, at S301, the application interface starts. At S302, it is determined whether the application interface includes a handwriting area. If the application interface includes a handwriting area, process S303 is executed to determine whether the application is the target application and that the target application meets the preset condition. At the fourth moment, process S304 is executed to call the vibration development software toolkit (SDK). Then, process S305 is executed to create a system call service to obtain the vibration parameter of the target application. Then, at the third moment, process S306 is executed to send the vibration parameter to a touchscreen controller 31 via an inter-process communication interface (IPC). After the vibration parameter is received, the touchscreen controller 31 can transmit the vibration parameter to the touchscreen hardware through the driver program, thereby controlling the touchscreen to respond to the vibration parameter in the first moment. That is, in the first moment, the touchscreen can respond to the operation object that needs the vibration parameter of the target application, such as an active stylus. At process S307, the stylus performs a touch operation in the second moment, that is, the stylus comes into contact with the touchscreen. The touchscreen detects the stylus touch operation, obtains the touch information, and then process S308 is executed to determine whether the stylus has contacted a handwriting area. If stylus has contacted the handwriting area, then process S309 is executed, and the vibration parameter is uploaded and fed back to the stylus 32.

Consistent with the present disclosure, when the target application meets the preset condition, a system call service is created at the fourth moment to obtain the vibration parameter of the corresponding target application. The vibration parameter is then sent to the touchscreen controller at the third moment via an inter-process communication interface, enabling the touchscreen to respond to the target application's vibration parameter at the first moment. The fourth moment is earlier than the third moment, and the third moment is earlier than the first moment. This ensures that when the target application meets the preset condition, a system call service can be created promptly to obtain the vibration parameter, the vibration parameter is then sent to the touchscreen controller via the inter-process communication interface, ensuring the touchscreen can respond to the target application's vibration parameter in a timely manner at the first moment.

In some embodiments, the target application includes a first application and a second application.

Process S101, determining that the target application meets the preset condition, and controlling the touchscreen to respond to the vibration parameter of the target application at a first moment, includes: detecting the startup of a first application interface, controlling the touchscreen to respond to a first vibration parameter of the first application at the first moment, such that the touchscreen sends the first vibration parameter to the stylus after the first moment; detecting the startup of a second application interface, controlling the touchscreen to respond to a second vibration parameter of the second application at the first moment, such that the touchscreen sends the second vibration parameter to the stylus after the first moment. The first application and the second application are different, and the first vibration parameter and the second vibration parameter are different.

Consistent with the present disclosure, the first application and the second application can start simultaneously, and the first application interface and the second application interface can be displayed on the touchscreen simultaneously. When the startup of the first application and the second application is detected, the touchscreen can be controlled to respond to the first vibration parameter of the first application and the second vibration parameter of the second application at the first moment.

Consistent with the present disclosure, after the startup of the first application interface is detected, the touchscreen responds to the first vibration parameter of the first application at the first moment and then controls the transmission of the first vibration parameter to the stylus after the first moment. Similarly, after the startup of the second application interface is detected, the touchscreen responds to the second vibration parameter of the second application at the first moment and then controls the transmission of the second vibration parameter to the stylus after the first moment. The first application and second application are different, and the first vibration parameter and second vibration parameter are different; this ensures that appropriate vibration feedback is provided when the stylus is used simultaneously with different applications.

In some embodiments, the vibration parameter includes touch area information, information on a plurality of writing types, and corresponding vibration intensity information.

Process S103, sending the vibration parameter of the target application from the touchscreen to the stylus, including: the touchscreen determining a target touch area corresponding to the stylus based on the touch information; determining a target writing type corresponding to the stylus; finding a target vibration intensity information corresponding to the target writing type and target touch area from the vibration parameter, and sending the target vibration intensity information to the stylus.

Consistent with the present disclosure, the touchscreen can detect touch operations of the stylus on the screen, identify the stylus's touch position information on the screen, and determine the target touch area corresponding to the stylus. In some embodiments, the touchscreen can detect touch operations of the stylus on the screen, receive touch position information sent by the stylus via downlink coding, and determine the target touch area corresponding to the stylus.

Consistent with the present disclosure, the stylus communicates with the touchscreen, for example, by sending the target handwriting type corresponding to the stylus to the touchscreen via downlink coding.

Consistent with the present disclosure, since the touch area and the writing type correspond to the vibration intensity in the vibration parameter, once the target touch area and target writing type are determined, the target vibration intensity information corresponding to the target writing type and target touch area can be found in the vibration parameter and sent to the stylus.

Consistent with the present disclosure, the target touch area corresponding to the stylus is determined by the touchscreen based on touch information; the target writing type corresponding to the stylus is determined; target vibration intensity information corresponding to the target writing type and target touch area is found from vibration parameter, and the target vibration intensity information is sent to the stylus. Therefore, the target vibration intensity information corresponding to the stylus can be determined on the electronic device end, and the stylus can directly vibrate based on the target vibration intensity information without needing to match the writing type, saving the stylus's computing resources.

In some embodiments, process S103, sending the vibration parameter of the target application from the touchscreen to the stylus, includes: encoding the vibration parameter of the target application based on the data encoding rules corresponding to the data channel between the touchscreen and the stylus, obtaining encoded vibration parameter; and sending the encoded vibration parameter to the stylus through the data channel.

Consistent with the present disclosure, the data channel between the touchscreen and the stylus can be a data encoding channel. The encoding rules can be optimized according to different application scenarios. For example, compression encoding technology can be used to reduce the amount of data, or the transmission speed can be increased by increasing the bandwidth of the data channel.

Consistent with the present disclosure, the vibration parameter of the target application is encoded based on the data encoding rules corresponding to the data channel between the touchscreen and the stylus, resulting in encoded vibration parameter. The encoded vibration parameter is then sent to the stylus via the data channel. This effectively reduces the latency of the vibration parameter during transmission, thereby improving the real-time performance of the stylus vibration.

In some embodiments, process S103, sending the vibration parameter of the target application from the touchscreen to the stylus, includes: if a first touch state indicating contact between the stylus and the touchscreen surface is detected, the touchscreen is controlled to send the vibration parameter of the target application to the stylus; if a second touch state indicating the stylus is at a preset distance from the touchscreen surface is detected, the touchscreen is controlled not to send the vibration parameter of the target application.

Consistent with the present disclosure, when the stylus contacts the touchscreen surface, the touchscreen monitors a first touch state and sends vibration parameter of the target application to the stylus. When the stylus is at a preset distance from the touchscreen surface, i.e., hovering over the touchscreen, the touchscreen monitors a second touch state and controls not to send vibration parameter. The first touch state can be detected by the stylus's pressure sensor or the touchscreen's capacitive sensor. Specifically, when the stylus's pressure sensor detects a certain pressure value, or the touchscreen's capacitive sensor detects contact with the stylus, the first touch state is determined. The second touch state can be detected by the stylus's distance sensor. When the stylus is more than a preset distance from the touchscreen surface, the second touch state can be determined.

Consistent with the present disclosure, by sending vibration parameter when the stylus contacts the touchscreen surface and not sending vibration parameter when the stylus is at a preset distance from the touchscreen surface, unnecessary vibration feedback is effectively reduced, improving the user experience.

The present disclosure also provides an information processing method applied to a stylus, as shown in FIG. 4. The information processing method includes the following.

At S401, a touch operation performed by the stylus on a display area of a target application of an electronic device is responded to.

Consistent with the present disclosure, the display area of the target application is the handwriting area of the target application. The stylus can perform a touch operation on the display area of the target application of the electronic devi

At S402, the vibration parameter of the target application sent by the touchscreen of the electronic device is received. The vibration parameter is sent to the target application of the touchscreen by the electronic device before the touch operation is detected in response to determining that the target application meets the preset condition.

Consistent with the present disclosure, when the electronic device determines that the target application meets the preset condition, and the stylus performs a touch operation on the display area of the target application of the electronic device, the touchscreen of the electronic device will send the vibration parameter of the target application to the stylus. The vibration parameter is sent to the target application of the touchscreen before the touch operation is detected by the touchscreen. Therefore, the stylus can receive the vibration parameter of the target application sent by the touchscreen of the electronic device. The vibration parameter may include information such as vibration intensity and vibration frequency.

At S403, based on vibration parameter, a vibration module is controlled to vibrate.

In specific implementation, the vibration module can be provided in the stylus. When the stylus obtains vibration parameter, the stylus can drive the vibration module to vibrate using vibration parameter.

The information processing method provided in the present disclosure is applied to a stylus. By responding to the stylus performing a touch operation on a display area of a target application of an electronic device; receiving vibration parameter of the target application sent by the touchscreen of the electronic device, the vibration parameter being sent to the target application by the electronic device before the touch operation is detected in response to determining that the target application meets the preset condition; and controlling the vibration module to vibrate based on the vibration parameter, therefore, the vibration feedback path can be reduced by receiving a predetermined vibration parameter sent by the touchscreen when the stylus performs a touch operation, allowing the stylus to respond to vibration immediately, thereby significantly reducing vibration latency and improving the user's perception of immediate feedback when using the stylus.

In some embodiments, the information processing method further includes the following.

During the touch operation, establishing a data channel between the touchscreen and the stylus, and transmitting the stylus's touch position information to the touchscreen via downlink coding of the data channel, such that the touchscreen can determine the vibration parameter of the target application based on the touch position information.

Correspondingly, receiving the vibration parameter corresponding to the touch position information of the target application sent by the touchscreen of the electronic device via uplink coding of the data channel.

Consistent with the present disclosure, downlink coding refers to the process of data transmission from the stylus to the touchscreen via the data channel, while uplink coding is the process of data transmission from the touchscreen to the stylus. Specifically, the data channel can be implemented using a wireless communication protocol to ensure the real-time performance and reliability of data transmission. Furthermore, the establishment of the data channel can be automatically triggered when the stylus approaches the touchscreen, thereby simplifying user operation.

Consistent with the present disclosure, by establishing a data channel during the touch operation, the stylus can transmit touch position information to the touchscreen. The touchscreen determines the vibration parameter of the target application based on this position information and transmits the vibration parameter to the stylus via the data channel. Upon receiving the vibration parameter, the stylus controls the vibration module to vibrate; this ensures real-time and reliable data transmission and significantly reduces vibration latency.

The present disclosure also provides an electronic device, including: a processor configured to determine that a target application meets the preset condition and control a touchscreen to respond to the vibration parameter of the target application at a first moment; and a touchscreen configured to respond by obtaining touch information from the stylus on the touchscreen at a second moment; sending the vibration parameter of the target application from the touchscreen to the stylus, causing the stylus to vibrate based on the vibration parameter of the target application, the second moment being later than the first moment.

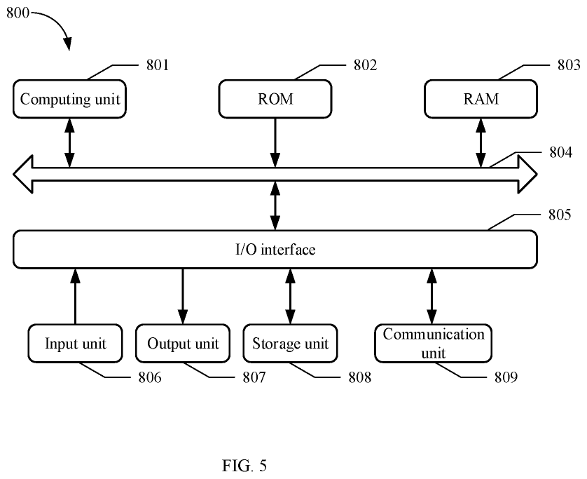

FIG. 5 shows a structural schematic diagram of an electronic device 800 that can be used to implement embodiments of the present disclosure. The electronic device is intended to represent various forms of digital computers, such as laptop computers, desktop computers, workstations, personal digital assistants, servers, blade servers, mainframe computers, and other suitable computers. The electronic device can also represent various forms of mobile devices, such as personal digital processors, cellular phones, smartphones, wearable devices, and other similar computing devices. The components, the connections and relationships between the components, and the functions of the components shown herein are merely examples and are not intended to limit the implementation of the present disclosure described and/or claimed herein.

As shown in FIG. 5, the electronic device 800 includes a computing unit 801 performing various appropriate actions and processes based on a computer program stored in a read-only memory (ROM) 802 or a computer program loaded from a storage unit 808 into a random access memory (RAM) 803. The RAM 803 may also store various programs and data needed for the operation of the electronic device 800. The computing unit 801, ROM 802, and RAM 803 are interconnected via a bus 804. An input/output (I/O) interface 805 is also connected to the bus 804.

Multiple components in the electronic device 800 are connected to the I/O interface 805, including: an input unit 806, such as a keyboard, mouse, etc. ; an output unit 807, such as various types of touchscreens, speakers, etc.; a storage unit 808, such as a disk, optical disk, etc.; and a communication unit 809, such as a network card, modem, wireless transceiver, etc. The communication unit 809 allows the electronic device 800 to exchange information/data with other devices via computer networks such as the Internet and/or various telecommunications networks.

The computing unit 801 can be a variety of general-purpose and/or dedicated processing components with processing and computing capabilities. Some examples of the computing unit 801 include, but are not limited to, a central processing unit (CPU), a graphics processing unit (GPU), various dedicated artificial intelligence (AI) computing chips, various computing units running machine learning model algorithms, a digital signal processor (DSP), and any suitable processor, controller, microcontroller, etc. The computing unit 801 performs the various methods and processes described above, such as information processing methods. For example, in some embodiments, the information processing method may be implemented as a computer software program tangibly included in a machine-readable medium, such as storage unit 808. In some embodiments, part or all of the computer program may be loaded and/or installed on the electronic device 800 via ROM 802 and/or communication unit 809. When the computer program is loaded into RAM 803 and executed by the computing unit 801, one or more processes of the information processing methods described above may be performed. In some embodiments, computing unit 801 may be configured to perform information processing methods by any other suitable means (e.g., by means of firmware).

Various embodiments of the systems and techniques described above herein can be implemented in digital electronic circuit systems, integrated circuit systems, field-programmable gate arrays (FPGAs), application-specific integrated circuits (ASICs), application-specific standard products (ASSPs), system-on-a-chip (SoCs), complex programmable logic devices (CPLDs), computer hardware, firmware, software, and/or combinations thereof. These various embodiments may include implementations in one or more computer programs that can be executed and/or interpreted on a programmable system including at least one programmable processor, which may be a dedicated or general-purpose programmable processor, capable of receiving data and instructions from a storage system, at least one input device, and at least one output device, and transferring data and instructions to the storage system, the at least one input device, and the at least one output device.

Program code for implementing the methods of the present disclosure may be written in any combination of one or more programming languages. This program code can be provided to a processor or controller of a general-purpose computer, special-purpose computer, or other programmable data processing apparatus, such that when executed by the processor or controller, the program code causes the functions/operations specified in the flowcharts and/or schematic diagrams to be implemented. The program code can be executed entirely on the machine, partially on the machine, as a standalone software package partially on the machine and partially on a remote machine, or entirely on a remote machine or server.

In the context of the present disclosure, a machine-readable medium can be a tangible medium that may contain or store a program for use by or in conjunction with an instruction execution system, apparatus, or device. A machine-readable medium can be a machine-readable signal medium or a machine-readable storage medium. Machine-readable media can be, but is not limited to, electronic, magnetic, optical, electromagnetic, infrared, or semiconductor systems, apparatus, or devices, or any suitable combination of the foregoing. More specific examples of machine-readable storage media include electrical connections based on one or more wires, portable computer disks, hard disks, random access memory (RAM), read-only memory (ROM), erasable programmable read-only memory (EPROM or flash memory), optical fiber, portable compact disk read-only memory (CD-ROM), optical storage devices, magnetic storage devices, or any suitable combination of the foregoing.

To provide interaction with a user, the systems and techniques described herein can be implemented on a computer having: a display apparatus for displaying information to the user (e.g., a CRT (cathode ray tube) or LCD (liquid crystal display) monitor); and a keyboard and pointing apparatus (e.g., a mouse or trackball) through which the user provides input to the computer. Other types of apparatus may also be used to provide interaction with the user; for example, feedback provided to the user can be any form of sensory feedback (e.g., visual feedback, auditory feedback, or tactile feedback); and input from the user can be received in any form (including sound input, voice input, or tactile input).

The systems and technologies described herein can be implemented in computing systems that include backend components (e.g., as data servers), or middleware components (e.g., application servers), or frontend components (e.g., user computers with graphical user interfaces or web browsers through which users can interact with implementations of the systems and technologies described herein), or any combination of such backend, middleware, or frontend components. The components of the system can be interconnected via digital data communication of any form or medium (e.g., communication networks). Examples of communication networks include local area networks (LANs), wide area networks (WANs), and the Internet.

Computer systems can include clients and servers. Clients and servers are generally geographically distant and typically interact via communication networks. Client-server relationships are created by computer programs running on respective computers and having client-server relationships with each other. Servers can be cloud servers, servers for distributed systems, or servers incorporating blockchain technology.

It should be understood that processes can be reordered, added, or deleted using the various forms of processes shown above. For example, the processes described in the present disclosure can be performed in parallel, sequentially, or in different orders, as long as the desired result of the technical solution disclosed in the present disclosure can be achieved, and the present disclosure does not limit on this.

Furthermore, the terms associated with “first” and “second” are used for descriptive purposes only and should not be construed as indicating or implying relative importance or implicitly specifying the number of indicated technical features. Therefore, a feature associated with “first” or “second” may explicitly or implicitly include at least one of that feature. In the description of the present disclosure, “multiple” means two or more, unless otherwise explicitly defined.

The above description is merely a specific embodiment of the present disclosure, but the scope of the present disclosure is not limited thereto. Any variations or substitutions that can be easily conceived by those skilled in the art within the scope of the technology disclosed in the present disclosure should be included within the scope of the present disclosure. Therefore, the scope of the invention should be determined by the scope of the claims.

What is claimed is:

1. An information processing method comprising:
determining that a target application meets a preset condition, and controlling a touchscreen to respond to a vibration parameter of the target application at a first moment;
obtaining touch information of a stylus on the touchscreen at a second moment later than the first moment; and
controlling the touchscreen to send the vibration parameter to the stylus, to enable the stylus to vibrate based on the vibration parameter.

2. The method according to claim 1, wherein, determining that the target application meets the preset condition, and controlling the touchscreen to respond to the vibration parameter at the first moment, includes:
detecting that an interface of the target application is launched or the target application is launched, and sending the vibration parameter to the touchscreen at a third moment earlier than the first moment, to enable the touchscreen to send the vibration parameter to the stylus after the first moment.

3. The method according to claim 1, wherein, determining that the target application meets the preset condition, and controlling the touchscreen to respond to the vibration parameter at the first moment, includes:
in response to the target application meeting the preset condition, creating a system call service at a fourth moment to obtain the vibration parameter corresponding to the target application; and
sending the vibration parameter to a touchscreen controller through an inter-process communication interface at a third moment later than the fourth moment and earlier than the first moment, to enable the touchscreen to respond to the vibration parameter at the first moment.

4. The method according to claim 1, wherein:
the target application includes a first application and a second application different from the first application; and
determining that the target application meets the preset condition, and controlling the touchscreen to respond to the vibration parameter at the first moment includes:
detecting that an interface of the first application is launched, controlling the touchscreen to respond to a first vibration parameter of the first application at the first moment, to enable the touchscreen to send the first vibration parameter to the stylus after the first moment; or
detecting that an interface of the second application is launched, controlling the touchscreen to respond to a second vibration parameter of the second application at the first moment, to enable the touchscreen to send the second vibration parameter to the stylus after the first moment, the first vibration parameter and the second vibration parameter being different.

5. The method according to claim 1, wherein:
the vibration parameter includes touch area information, information on a plurality of writing types, and vibration intensity information corresponding to the plurality of writing types; and
controlling the touchscreen to send the vibration parameter to the stylus includes:
controlling the touchscreen to determine a target touch area corresponding to the stylus based on the touch information;
determining a target writing type corresponding to the stylus; and
finding target vibration intensity information corresponding to the target writing type and the target touch area from the vibration parameter, and sending the target vibration intensity information to the stylus.

6. The method according to claim 1, wherein controlling the touchscreen to send the vibration parameter to the stylus includes:
encoding the vibration parameter based on a data encoding rule corresponding to a data channel between the touchscreen and the stylus to obtain an encoded vibration parameter; and
sending the encoded vibration parameter to the stylus through the data channel.

7. The method according to claim 1, wherein controlling the touchscreen to send the vibration parameter to the stylus includes:
in response to detecting a first touch state indicating that the stylus is in contact with a surface of the touchscreen, controlling the touchscreen to send the vibration parameter to the stylus; or
in response to detecting a second touch state indicating that the stylus is at a preset distance from the surface of the touchscreen, controlling the touchscreen not to send the vibration parameter.

8. A non-transitory computer-readable storage medium storing instructions that, when executed by a processor, cause an electronic device including the processor to perform the method according to claim 1.

9. An information processing method comprising:
responding to a touch operation performed by a stylus on a display area of a target application of an electronic device;
receiving a vibration parameter of the target application sent by a touchscreen of the electronic device, the vibration parameter being sent to the touchscreen by the electronic device before the touch operation is detected in response to determining that the target application meets a preset condition; and
based on the vibration parameter, controlling a vibration module to vibrate.

10. The method according to claim 9, further comprising:
during the touch operation, establishing a data channel between the touchscreen and the stylus, and transmitting touch position information of the stylus to the touchscreen via downlink coding of the data channel, to enable the touchscreen to determine the vibration parameter based on the touch position information; and
receiving the vibration parameter corresponding to the touch position information transmitted by the touchscreen via uplink coding of the data channel.

11. A non-transitory computer-readable storage medium storing instructions that, when executed by a processor, cause a stylus including the processor to perform the method according to claim 9.

12. A stylus comprising:
a processor; and
a memory storing instructions that, when executed by the processor, cause the stylus to perform the method according to claim 9.

13. An electronic device comprising:
a touchscreen; and
a processor configured to:
determine that a target application meets a preset condition, and control the touchscreen to respond to a vibration parameter of the target application at a first moment;
obtain touch information of a stylus on the touchscreen at a second moment later than the first moment; and control the touchscreen to send the vibration parameter to the stylus, to enable the stylus to vibrate based on the vibration parameter.

14. The electronic device according to claim 13, wherein the processor is further configured to, when determining that the target application meets the preset condition, and controlling the touchscreen to respond to the vibration parameter at the first moment:
detect that an interface of the target application is launched or the target application is launched, and send the vibration parameter to the touchscreen at a third moment earlier than the first moment, to enable the touchscreen to send the vibration parameter to the stylus after the first moment.

15. The electronic device according to claim 13, the processor is further configured to, when determining that the target application meets the preset condition, and controlling the touchscreen to respond to the vibration parameter at the first moment:
in response to the target application meeting the preset condition, create a system call service at a fourth moment to obtain the vibration parameter corresponding to the target application; and
send the vibration parameter to a touchscreen controller through an inter-process communication interface at a third moment later than the fourth moment and earlier than the first moment, to enable the touchscreen to respond to the vibration parameter at the first moment.

16. The electronic device according to claim 13, wherein:
the target application includes a first application and a second application different from the first application; and
the processor is further configured to, when determining that the target application meets the preset condition, and controlling the touchscreen to respond to the vibration parameter at the first moment:
detect that an interface of the first application is launched, control the touchscreen to respond to a first vibration parameter of the first application at the first moment, to enable the touchscreen to send the first vibration parameter to the stylus after the first moment; or
detect that an interface of the second application is launched, control the touchscreen to respond to a second vibration parameter of the second application at the first moment, to enable the touchscreen to send the second vibration parameter to the stylus after the first moment, the first vibration parameter and the second vibration parameter being different.

17. The electronic device according to claim 13, wherein:
the vibration parameter includes touch area information, information on a plurality of writing types, and vibration intensity information corresponding to the plurality of writing types; and
the processor is further configured to, when controlling the touchscreen to send the vibration parameter to the stylus:
control the touchscreen to determine a target touch area corresponding to the stylus based on the touch information;
determine a target writing type corresponding to the stylus; and
find target vibration intensity information corresponding to the target writing type and the target touch area from the vibration parameter, and send the target vibration intensity information to the stylus.

18. The electronic device according to claim 13, wherein the processor is further configured to, when controlling the touchscreen to send the vibration parameter to the stylus:
encode the vibration parameter based on a data encoding rule corresponding to a data channel between the touchscreen and the stylus to obtain an encoded vibration parameter; and
send the encoded vibration parameter to the stylus through the data channel.

19. The electronic device according to claim 13, wherein the processor is further configured to, when controlling the touchscreen to send the vibration parameter to the stylus:
in response to detecting a first touch state indicating that the stylus is in contact with a surface of the touchscreen, control the touchscreen to send the vibration parameter to the stylus; or
in response to detecting a second touch state indicating that the stylus is at a preset distance from the surface of the touchscreen, control the touchscreen not to send the vibration parameter.
